(19) United States
(12) Patent Application Publication
(10) Pub. No.: US 2024/0367719 A1
(43) Pub. Date: Nov. 7, 2024

(54) Multi-Car Steering System

(71) Applicant: TDI GREENWAY TECHNOLOGIES LTD., Warwickshire (GB)

(72) Inventors: Adrian Howson, Warwickshire (GB); Matthew Hall, Warwickshire (GB); Paul Salkeld, Warwickshire (GB)

(21) Appl. No.: 18/714,766

(22) PCT Filed: Nov. 30, 2022
(86) PCT No.: PCT/GB2022/053033

§ 371 Date: May 30, 2024

(30) Foreign Application Priority Data
Nov. 30, 2021 (GB) 2117315.8
Nov. 30, 2021 (GB) 2117316.6
Nov. 30, 2021 (GB) 2117317.4

(51) Int. Cl. B62D 12/00; B60D 1/173; B60D 1/48

(52) U.S. Cl. CPC B62D 12/00; B60D 1/173; B60D 1/481

(57) ABSTRACT

A steering system for a multi-car mass transit vehicle, the steering system providing a four-wheel Ackermann-type system for providing improved manoeuvrability of each car and bi-directional travel, with each car accurately following the path of the car in front when travelling in either a forward or backward direction. Alternatively, there is provided: an intermediate carriage for a multi-carriage vehicle, the intermediate carriage configured to connect to first and second carriages, and the intermediate carriage including a steering input and a steering output, such that the steering input is configured to accept a steering input from the first carriage, and the steering output is configured to provide a steering output to the second carriage. Further alternatively, there is provided a tyre-wheeled bogie arrangement for a vehicle, the bogie arrangement including a bogie body and at least one wheel including a tyre.

This specification relates to steering systems for multi-car mass transit vehicles. In particular, although not exclusively, this specification relates to a bidirectional steering system for multi-car mass transit vehicles. Further, it is a non-exclusive object of this specification to provide a steering system that is more versatile, deployable and provides a tighter radius of steering.

Multi-car mass transit vehicles such as roadtrams comprise several connected cars on tyres which can accommodate large numbers of people without the need for physical tracks.

Generally, industry uses a variant of what is known as four-wheel “Ackermann” (‘4WA’) steering to ensure each car in a roadtram follows exactly a front (steering) car, minimising the track width required in crowded situations, four-wheel “Ackermann” steering is not to be confused with conventional “Ackermann” steering methods which are generally operable on two-wheel steering arrangements.

4WA steering as known and in common with all multi-trailer systems cannot operate bi-directionally and will often quickly jack-knife when reversing—a limitation which would require additional route flexibility and laying of additional track or road to ensure the train or roadtram may always travel in a forward direction.

In particular, local mass transit vehicles in crowded streets and/or narrow streets are looking to steering mechanisms which may enable the vehicle to circumnavigate obstacles easily. To achieve the desired manoeuvrability required for a city centre, semi-trailer steering would not be appropriate as the trailing cars will not follow the track of the lead car, and may cut into corners. A 4WA arrangement would enable the trailers to follow exactly the path of the lead car, but like all multi-trailer steering systems, this type of 4WA arrangement is conventionally uni-directional.

The lack of a bidirectional four-wheel Ackermann-style steering mechanism remains an impediment in implementing a long bi-directional multi-car roadtram in an urban setting and it would indeed be difficult for a multi-car road-train to operate in such tight locations. Further, operators of such vehicles may be surprised when they are informed that roadtrams cannot reverse.

Lightweight hand-towed trailers can have a detachable drawbar which can be fitted to either end of the trailer for pulling the trailer in the second direction. This differs from the present invention which applies to large road-going trains where the bi-directionality is integrated into the steering system such that a driver may switch directions without the need to remove drawbars.

Multi-car road vehicles, whether they use 4WA, semi-trailer or pivot steering, cannot adequately reverse—a system that relies on the drawbar to convey steering information to the car behind has been found not to work the other way around.

Non-4WA semi-trailer systems are inaccurate following a path when following a power car which means they are unsuitable for constricted urban environments.

An example of a multi-carriage roadtram is the Zhuzhou autonomous tram. However, the individual carriages in the Zhuzhou autonomous tram each follow a fixed path using buried wires and/or visual guides on the road for direction. Therefore, this example does not provide the desired versatility, relying on prepared infrastructure for direction.

There is, therefore, a need to provide a multi-car mass transit vehicle steering system which alleviates one or more problems associated with the prior art.

A first aspect provides a steering system for a multi-car mass transit vehicle, the steering system comprising a drawbar attachable to steering systems of first and second cars of the multi-car mass transit vehicle, wherein the steering system is configured such that the drawbar provides the steering input for the first car when configured to move in a first direction, and provides the steering input for the second car when configured to move in a second direction.

The steering system may further comprise a first wheel axle and a second wheel axle, the drawbar being connected to the first wheel axle and the second wheel axle such that the drawbar steering input provides the steering input for the first and second wheel axles.

The drawbar steering input may steer the first wheel axle in an opposite direction to the second wheel axle.

The drawbar steering input may provide a steering input to the first wheel axle and may connect to the second wheel axle such that the second wheel axle steers in an opposite direction to the first wheel axle.

The steering systems of the first and second cars may be four-wheel steering systems.

The steering systems of the first and second cars may steer two wheels in a first direction and two wheels in an opposite direction.

The steering systems of the first and second cars may comprise a bellcrank or turntable and rigid linkage arrangement, the drawbar being attached to the bellcrank or turntable, the bellcrank or turntable being attached to rigid linkages, the rigid linkages being attached to wheel mounts of the car such that movement of the drawbar moves the first and second wheel axles and wheel mounts.

The steering systems of the first and second cars may further comprise a crank located adjacent a first wheel axle, the crank being connected, via rigid linkages, to the bellcrank or turntable and the wheel mounts of the first wheel axle.

The steering system may further comprise a second crank located adjacent a second wheel axle and connected to a second bellcrank or turntable and wheel mounts of the second axle wherein the second crank is connected to the first crank.

A drawbar of another car may be attached to the second bellcrank or turntable.

The first crank may be connected to the second crank at opposing attachment portions such that rotation of one crank causes opposite rotation of the other crank.

The crank may be formed of a T-piece configured to relay linear movement of the rigid linkages.

The steering system may further comprise one or more centring linkages operable to either restrict or permit limited movement of the drawbar relative to the bellcrank or turntable.

The centring linkages may be pneumatic centring linkages.

The steering system may further comprise a switch for a driver or operator of the vehicle which controls when the pneumatic centring linkages either restrict or permit limited movement of the drawbar relative to the bellcrank or turntable.

Centring linkages may be provided for each bellcrank or turntable such that movement at each end of the drawbar may be permitted or restricted relative to the respective bellcrank or turntable.

The steering systems of the first and second cars may comprise a hydraulic system, the hydraulic system comprising first and second pistons, the first and second pistons each being attached to opposite sides of the drawbar and in fluid connection with first and second wheel mount pistons.

The hydraulic system may further comprise third and fourth pistons each being attached to opposite sides of a second drawbar and in fluid connection with first and second wheel mount pistons.

The hydraulic system may be a closed loop system, all the pistons being in fluid connection.

The hydraulic system may comprise a switch for a driver or operator of the vehicle which controls when the pistons either restrict or permit limited movement of the drawbar.

A second aspect provides a method of steering a multi-car mass transit vehicle, the method comprising: connecting a plurality of cars via drawbars, a steering system of each car being configured for the drawbars to provide an input to the steering systems; setting a switch to activate each steering system for a desired direction of travel; and driving the multi-car mass transit vehicle.

The method may further comprise: reaching a destination; switching the steering systems to a different desired direction; and driving the multi-car mass transit vehicle.

Setting a switch to activate each steering system or switching the steering system to a different desired direction may comprise: when configured to travel in a first direction, the steering system restricts movement of all the drawbars of the multi-car mass transit vehicle at each same first end and permits limited movement of all the drawbars at each same second end, and when configured to travel in a second direction, the steering system restricts movement of the all the drawbars of the multi-car mass transit vehicle at a same second end and permits limited movement of all the drawbars at the same first end.

The multi-car mass transit vehicle may be driven by a power car or each car comprises bi-directional electric motors and a power supply.

A third aspect provides a multi-car mass transit vehicle comprising the steering system.

A fourth aspect provides a kit comprising the steering system and a plurality of cars.

Embodiments of the steering system are described, by way of example, with reference to the accompanying drawings, in which:

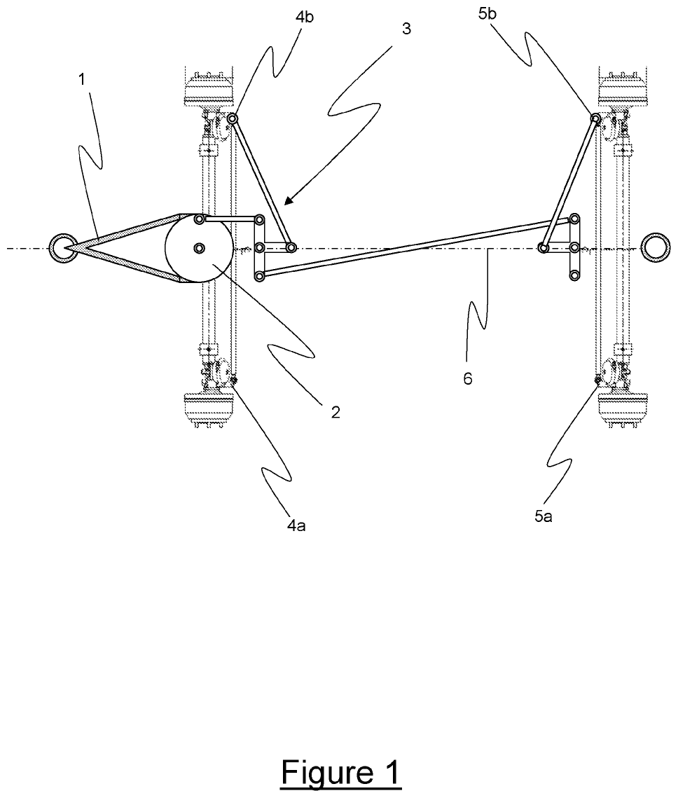

FIG. 1 shows a schematic of a conventional 4WA steering system;

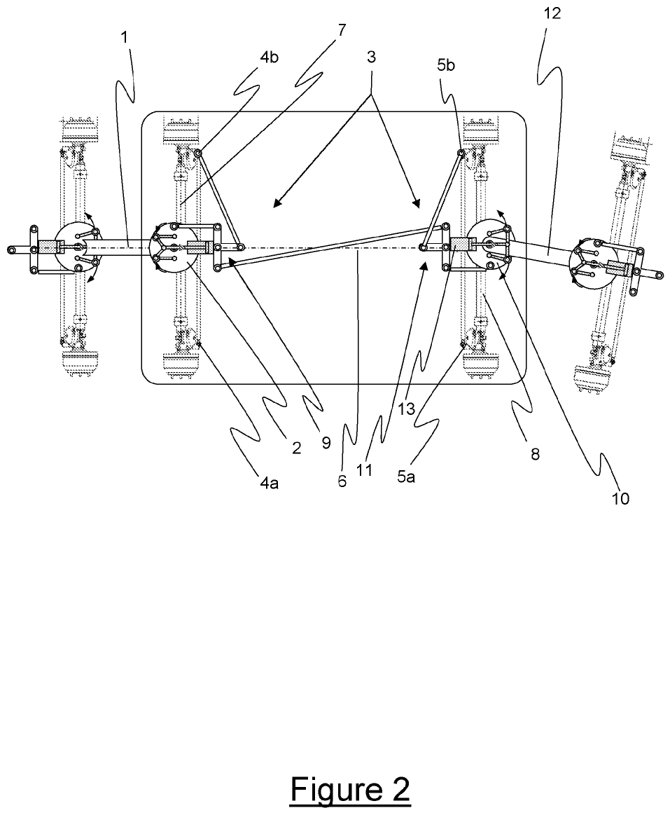

FIG. 2 shows a schematic example of a pneumatically operated 4WA steering system; and

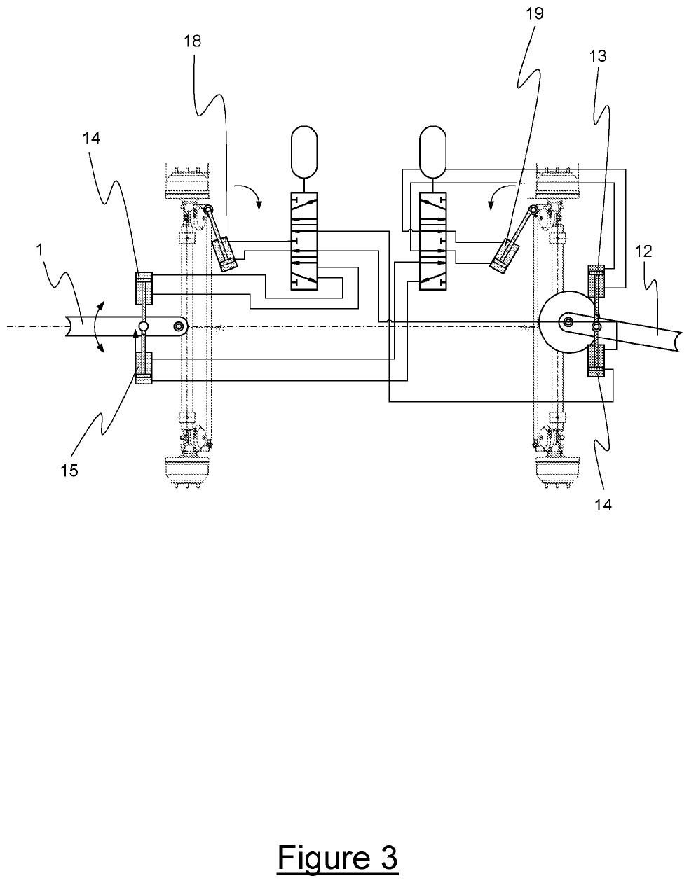

FIG. 3 shows a schematic example of a hydraulically operated 4WA steering system.

Referring firstly to FIG. 1, there is shown a conventional uni-directional 4WA steering system including one-way linkages and a bell crank system. In use, a drawbar (1), which is fixed to a bellcrank or turntable (2), rotates about a bellcrank or turntable pivot axis. Linkages (3) connected to the bellcrank or turntable (2), first (4a, 4b) wheel mounts and second (5a, 5b) wheel mounts (and therefore wheels) turn the first (4a, 4b) and second (5a, 5b) wheel mounts based on the geometry of the bellcrank or turntable (2) and linkages (3). The geometry is configured such that when the car is turning, the inner wheel(s) of the turning circle (4a and 5a or 4b and 5b) are turned at a greater angle from the centre line (6) than the outer wheel(s) (4b and 5b or 4a and 5a). This reduces slip of the outer wheels when turning and provide greater stability and control of the car in use.

The linkage geometry is configured to turn the second wheel mounts (5a, 5b) in an opposite rotation direction to the first wheel mounts (4a, 4b). This may provide a smaller turning circle. As illustrated in FIG. 1, 4WA currently only functions when travelling in one direction—in the example illustrated in FIG. 1 this is towards the left-hand side of the figure.

A bi-directional steering system is illustrated in FIG. 2 for a multi-car mass transit vehicle. A schematic of a single car is illustrated within the enclosed box. FIG. 2 illustrates a series of cars moving from right to left.

The steering system may comprise a first wheel axle (7). The first wheel axle (7) may comprise one or more first wheel mounts (4a, 4b) and wheels. The first wheel axle (7) may be positioned at the front of a car, for example, the front being the direction of travel. In this particular embodiment, two first wheel mounts are shown (4a, 4b), one mounted at each end of the first wheel axle (7). The wheel mounts may be rotatably mounted to the wheel axle as known in the art. Wheels may be mounted on the wheel mounts.

The steering system may further comprise a second wheel axle (8). The second wheel axle (8) may comprise one or more second wheel mounts (5a, 5b) and wheels. The second wheel axle (8) may be positioned at the rear of a car with respect to the direction of travel, for example. Both the first (7) and second (8) wheel axles may be parts of the same car and may be mounted on a car chassis.

The steering system may comprise a drawbar (1). The drawbar (1) may be removably attachable to a bellcrank or turntable (2). The bellcrank or turntable (2) may be rotatably mounted to the car chassis. The drawbar (1) may be attachable to a bellcrank or turntable (2) at one end, another end of the drawbar (1) being attachable to another bellcrank or turntable (2) of another car, as illustrated in FIG. 2. This may be advantageous to connect a series of cars in the multi-car vehicle. In embodiments, one end of the drawbar (1) may be attachable to a simple tow hitch as known in the art.

In embodiments, the bellcrank or turntable (2) may be connected to a T-piece (9). The T-piece (9) may be a crank. The T-piece may be rotatably attached to the car chassis, and positioned adjacent the first wheel axle (7). The T-piece (9) may include three attachment portions. Each of the three attachment portions may be positioned at three extremities of the T. The bellcrank or turntable (2) may be connected to one of the T-piece attachment portions via a first rigid linkage. The first rigid linkage may be connected to the bellcrank or turntable (2) at an outer radius of the bellcrank or turntable (2). When the car is directly behind the car in front, the first rigid linkage may be parallel to the drawbar (1). The T-piece (9) may be connected to one of the first wheel mounts (4b) via a second rigid linkage. The second rigid linkage may be connected to the T-piece (9) at a second of the attachment portions. A third rigid linkage may be connected between two of the first wheel mounts (4a, 4b). The T-piece (9) may be a crank to convert motion of the bellcrank or turntable (2) to the wheel mounts (4a, 4b, 5a, 5c). Other shapes of crank that provide the same effect may be provided.

The steering system may include a second bellcrank or turntable (10), T-piece (11), and linkages positioned adjacent the second wheel axle (8), linked in a similar but opposing arrangement to the above. This may be advantageous to turn the rear wheels in an opposite direction to the front wheels.

The second T-piece (11) may be rotatably attached to the car chassis, and positioned adjacent the second wheel axle (8). The second T-piece (11) may be a crank. The second T-piece (11) may include three attachment portions. Each of the three attachment portions may be positioned at the three extremities of the T. The second bellcrank or turntable (10) may be connected to one of the second T-piece attachment portions via a first rigid linkage. The first rigid linkage may be connected to the second bellcrank or turntable (10) at an outer radius of the second bellcrank or turntable (10). This outer radius may be an outer radius that is opposite (for example, 180 degrees) from the first outer radius of the first bellcrank or turntable (2) with respect to the centre axis (6). In this second arrangement, when the car is directly behind the car in front, the first rigid linkage may be parallel to the drawbar (1). The second T-piece (11) may be connected to one of the second wheel mounts (5b) via a second rigid linkage. The second rigid linkage may be connected to the second T-piece (11) at a second of the attachment portions. A third rigid linkage may be connected between two of the second wheel mounts (4a, 4b). The second T-piece (11) may be a crank to convert motion of the second bellcrank or turntable (10) to the wheel mounts (4a, 4b, 5a, 5c). Other shapes of crank that provide the same effect may be provided.

In embodiments, the first T-piece (9) and second T-piece (11) may be combined cranks to convert motion of the first and/or second bellcrank or turntable (2, 10) to turn the wheel mounts (4a, 4b, 5a, 5c). A fourth rigid linkage may connect the first T-piece (9) with the second T-piece (11) at each third attachment portion of both the first and second T-pieces. The third attachment portion of the first T-piece (9) may be diametrically opposed to the third attachment portion of the second T-piece (11).

The rigid linkages (3) may be linear linkages (3). The rigid linkages (3) may all freely rotate at their connections. An example of a rigid linear linkage may be a steel rod. The linkages (3) may include one or more protrusions or apertures at each end to connect with an opposing aperture or protrusion of the connecting linkage or connecting element. Each connection may include a bearing. This may be advantageous to provide a hard-wearing connection.

In use, the drawbar (1) may rotate when turning thereby rotating the bellcrank or turntable (2). The bellcrank or turntable (2) may actuate movement of the first rigid linkage. The first rigid linkage may provide rotational movement of the first T-piece (9) thereby providing simultaneous movement of:
the second rigid linkage and third rigid linkage, thereby rotating the first wheel mounts (4a, 4b) and wheels; and
the second T-piece (11), in an opposing rotational direction to the first T-piece (9), thereby rotating the second wheel mounts (5a, 5b) in an equal opposing direction to the first wheel mounts (4a, 4b).

This may be advantageous to turn all the wheels simultaneously and provide a smaller turning circle, as all four wheel mounts and wheels on a car may contribute to the turning curve. Further, this may be advantageous as the drawbar following the car in front determines the angle of turn of the wheels, following the same line as the car in front.

A second drawbar (12), which may be the drawbar (1) of the next car, may be removably attachable to the second bellcrank or turntable (10). The second drawbar (12) may be engageable with the steering system of the car. In embodiments, one end of the second drawbar (12) may be attachable to a simple tow hitch as known in the art.

The steering system may include centring linkages. These centring linkages may clamp or unclamp the drawbar to the bellcrank or turntable. Clamping may lock the drawbar to the bellcrank or turntable so that when the drawbar rotates, the bellcrank or turntable rotates respectively activating four-wheel steering of the wheel mounts and wheels. Unclamping may allow the drawbar to rotate freely within a limited range so that when the drawbar rotates, the bellcrank or turntable does not rotate respectively and does not active the four-wheel steering of the wheel mounts and wheels.

The centring linkages may be mechanical, and may be manually actuated or include a linkage which may be disengaged or engaged manually. In embodiments, a lever may be provided to actuate the centring linkages. The lever may be outside and/or inside the car, preferably inside a driver or operator cabin. In embodiments, a long linkage may be provided which may attach to all the centring linkages of all the cars. This may be advantageous to actuate all centring linkages in all cars simultaneously.

Actuation of the centring linkages may be automated by mechanical and/or electrical and/or pneumatic actuation means. In a mechanical system gears may be provided, for movement of the centring linkages. This mechanical system may, for example, include a worm and wheel gear. This may enable automated actuation of a number of mechanical linkages via one lever. In embodiments, actuation of the centring linkages may be provided by electrical-mechanical or electromechanical means. For example, the centring linkages may be motor-driven, and as such, a motor may be provided for movement of the centring linkages. The motor may be a servomotor, and may be connected to the centring linkages by appropriate mechanical means, for example a mechanical linkage.

The motor may be connected to a controller, which may be a known type of motor controller, and may include a switch for engagement or disengagement of the centring linkages. To engage or disengage the centring linkages, a driver or operator may provide an input to the controller.

In some examples, the centring linkages may be mechanically engaged, frictionally engaged, or engaged by an alternative locking arrangement, which may include a protrusion and a suitable receiving aperture.

Preferably, actuation of the centring linkages may be automatic and pneumatically operable by a switch inside the driver or operator cabin. The switch may provide an electrical signal to a pneumatic piston attached to each centring linkage to clamp or unclamp the centring linkages.

Preferably, the steering system comprises one centring linkage for each set of (i) bellcrank or turntable and (ii) drawbar. For example, within a single car, a first centring linkage may be provided for the first bellcrank or turntable and drawbar, and a second centring linkage will be provided for the second bellcrank or turntable and second drawbar.

The centring linkages may be pneumatic centring linkages (13). Each pneumatic centring linkage may comprise a piston and cylinder filled with compressible air or another compressible gas. The piston may be connected to a plurality of rigid linkages which may be the centring linkages. The pneumatic piston may provide actuation of the centring linkages (13). The plurality of rigid linkages may form an ‘M’ arrangement. The piston may connect to the plurality of rigid linkages via the central vertex of the ‘M’ arrangement. The rigid linkages at the ends of the ‘M’ arrangement (the ‘corners’ forming the ‘start’ of the M and ‘end’ of the M) may be attached to the bellcrank or turntable, and may be attached such that they may rotate relative to the bellcrank or turntable. The three vertices of the ‘M’ linkage arrangement may be connected rotatably with respect to each other such that when the piston actuates, the movement at the central vertex ‘opens’ the two opposing peak vertices of the ‘M’ arrangement (moves the two vertices further apart from one another) or ‘closes’ the two opposing peak vertices of the ‘M’ arrangement (move the two vertices closer to one another).

Closing of the two opposing peak vertices of the ‘M’ arrangement (moving the two vertices closer to one another) may clamp the drawbar to the bellcrank or turntable. As the centring linkages may be attached to the bellcrank or turntable and engage the drawbar at each side, when the drawbar rotates the centring linkages must follow thereby rotating the bellcrank or turntable and actuating the four-wheel steering system of the car.

Opening of the two opposing peak vertices of the ‘M’ arrangement (moving the two vertices further apart from one another) may unclamp the drawbar from the bellcrank or turntable thereby allowing the drawbar to rotate without influencing the centring linkages and/or bellcrank or turntable (and therefore the four-wheel steering system of the car). When opened, the M arrangement may become a ‘W’ arrangement as illustrated in FIG. 2. This may be advantageous as the steering system may not be operable if, for example, all the drawbars are all clamped to all the bellcranks or turntables, or likewise if they are all unclamped.

The two peak vertices may include protrusions or retainment means such that may restrict rotational movement of the drawbar to between the two peak vertices. In an example, air or another gas enters the piston cylinder to move the piston in a first direction along a length of the cylinder. The piston then moves the central vertex of the linkages thereby moving the two peak vertices away from each other into the ‘open’ position. This allows a limited range of free rotational movement for the attached drawbar with respect to the bellcrank or turntable, limited by the positions of the peak vertices. When it is desired for the drawbar to be centred or ‘locked’ to the bellcrank or turntable, i.e. to engage the steering system, the piston is actuated to reposition the ‘M’ linkages back into the ‘closed’ ‘M’ arrangement. In a ‘closed’ position, the peak vertices enclose the drawbar (for example, each peak vertex engages opposing sides of the drawbar) such that no rotational movement of the drawbar is permitted with respect to the bellcrank or turntable. Any rotational movement of the drawbar also rotates the bellcrank or turntable thereby engaging the steering system. This may be advantageous to provide four-wheel Ackerman-type steering to the following car.

‘Opening’ or ‘closing’ of the pneumatic centring linkages (13) may be provided in a driver cabin of the multi-car mass transit vehicle. An operator or driver may control one or more switches that may actuate the pistons within the pneumatic cylinders, and therefore control which drawbars have restricted movement or limited free rotational movement.

Preferably, a first switch may ‘open’ all the first pneumatic centring linkages of all cars in the multi-car vehicle, and ‘close’ all the second pneumatic centring linkages of all cars in the multi-car vehicle. Further preferably, a second swich may ‘close’ all the first pneumatic centring linkages of all cars in the multi-car vehicle, and ‘open’ all the second pneumatic centring linkages of all cars in the multi-car vehicle. This switching system may be advantageous so that a four-wheel Ackerman-type system, that transfers along each car, may be operable when the multi-car mass transit vehicle is travelling in either a forward or backward direction.

It may be that if all the drawbars are free to rotate (unclamped) or that if all the drawbars are locked (clamped), four-wheel Ackermann-type steering is not transferred to the next car.

Now referring to FIG. 3, a hydraulic system may be used that emulates the steering arrangement of the bellcrank and linkage system above. The hydraulic system may include first (14), second (15), third (16) and fourth (17) pistons. The first and second pistons (14, 15) may each be fixed to opposite sides of the drawbar (1). The third and fourth pistons (16, 17) may each be fixed to opposite sides of the second drawbar (12). Further wheel mount pistons (18, 19), preferably one for each axle, are included which are in fluid connection with the first (14), second (15), third (16) and fourth (17) pistons. The first wheel mount piston (18) may actuate turning of the first wheel mount (4b). The second wheel mount piston (19) may actuate turning of the second wheel mount (5b). A rigid linkage may connect two of the first wheel mounts (4a, 4b) such that hydraulic actuation of one first wheel mount actuates both first wheel mounts (4a, 4b). A further rigid linkage may connect two of the second wheel mounts (5a, 5b) such that hydraulic actuation of one second wheel mount actuates both second wheel mounts (5a, 5b).

The pistons may be fluidly connected via a circuit. The circuit may be a closed loop circuit. The circuit may comprise a plurality of valves. The valves may be operable via switches provided in a driver cabin of the multi-car mass transit vehicle. An operator or driver may control one or more switches that actuate the valves, and therefore controls which pistons are active and idle, and which drawbars have restricted movement or limited free rotational movement.

Preferably, a first switch may ‘activate’ all the first and second pistons (14, 15) of all cars in the multi-car vehicle, and ‘idle’ all the third and fourth pistons (16, 17) of all cars in the multi-car vehicle. Further preferably, a second swich may ‘idle’ all the first and second pistons (14, 15) of all cars in the multi-car vehicle, and ‘activate’ all the third and fourth pistons (16, 17) of all cars in the multi-car vehicle. This switching system may be advantageous so that a four-wheel Ackerman-type system, that follows along each car, may be operable when the multi-car mass transit vehicle is travelling in either a forward or backward direction.

It may be that if all the drawbars are free to rotate or that if all the drawbars are centred, four-wheel Ackermann-type steering is not transferred to the next car.

In an example of use, a multi-car mass transit vehicle may comprise two end cars and one or more intermediate cars. All of the cars may comprise the steering system. The end cars may have only one of the first or second drawbars attached. For example, the front car (with respect to the direction of travel) may only have the second, rearward, drawbar attached, and the rear car may only have the first, frontward, drawbar attached.

A driver or operator may set the steering system to engage in the direction of desired travel as disclosed above. The multi-car vehicle may comprise a drive car at each end. Each drive car may comprise a drive system that may drive the multi-car vehicle in a different direction. Each drive car may comprise a power supply, for example a battery, connected to one or more electric motors to drive the wheels. Alternatively, each car may comprise a power supply and electric motors, for example servo motors, to power each car independently. Servo motors may provide bi-directional drive to the cars while the steering system may provide bi-directional steering. The driver or operator may control the speed of the motors via a controller.

The multi-car vehicle steering system may comprise a combination of the bellcrank or turntable and linkages system, and the hydraulic system.

When travelling, each drawbar may be locked to the steering system at each (i) first bellcrank or turntable (2), and/or (ii) first and second pistons (14, 15), such that when the car in front car turns, the steering system of the car is engaged and it follows the line of the car in front. As each second pneumatic centring linkages (13), or third (16) and fourth (17) pistons of the hydraulic system, are disengaged with the second drawbar (12) (the drawbar (1) of the next car), rotation of the second drawbar does not affect the steering system of the car, only the steering system of the next car.

When the vehicle reaches a destination, it may need to reverse. The driver or operator may simply switch the desired direction as disclosed above. The steering system may now be operable in the ‘reverse’ direction in the same way it was in the ‘forward’ direction. As such, the previous end car is now the front car and may operate in the same way as disclosed above, and there is no need to attempt to turn the whole multi-car vehicle in order to travel in the reverse direction.

In embodiments, the steering system may be retrofitted to existing multi-car vehicles. Accordingly, a kit of parts is provided comprising the steering system and a plurality of cars.

A method of steering a multi-car mass transit vehicle is also provided. The method comprises connecting a plurality of cars via drawbars, the drawbars providing an input to the steering system of a connected car; setting a switch to activate each steering system for a desired direction of travel (as disclosed above); and driving the multi-car mass transit vehicle. The method may further comprise reaching a destination; switching the steering systems to a different desired direction (as disclosed above); and driving the multi-car mass transit vehicle in that different direction. This may be advantageous so as to travel in two directions with the same multi-car mass transit vehicle without the need to turn around or use extra space and routing to turn around, thereby providing a more versatile mass-transit vehicle, particularly in tight spaces or streets where obstacles need to be avoided or there may not be infrastructure to turn around. Further, the steering system provides more predictability in the path the follower cars will travel providing a safer vehicle, particularly in crowded pedestrian areas.

One example of a multi-car mass transit vehicle may be a roadtram. This may be advantageous so that multi-car vehicle may travel in two directions without the need for additional infrastructure and be more manoeuvrable and versatile in tighter spaces.

In some embodiments, the precision of the steering of a roadtram with or without bidirectionality may be further enhanced by a guidance system such as Wireguide®. If the Wireguide® system and the bi-directional steering system are combined, the operator or driver will be able to take advantage of automatic and reliable precision steering of long vehicles, with a combined steering error of around 100 mm—when needed—with the ability to depart from the prepared route when necessary.

It will be appreciated that the disclosed embodiments are not restricted by size or type of vehicle and can be applied to many different multi-car steering systems, for example, with power-assist steering systems. While the steering system may be particularly suitable for road vehicles, rail vehicles may also benefit from the steering system.

It will be appreciated that the steering system may be advantageous for turning of a multi-car mass transit vehicle. Conversely, it may be advantageous to de-tune or disengage the steering system at high speeds due to possible weaving of the cars.

### Description

This specification relates to intermediate carriage systems for multi-car mass transit vehicles. In particular, although not exclusively, this specification relates to an intermediate, bi-directional carriage system for multi-car mass transit vehicles. Further, it is a non-exclusive object of this specification to provide a mass-transit vehicle carriage system that is more versatile, deployable and provides an opportunity to provide gangways between carriages, and also has the potential to provide for a tighter radius of steering.

Multi-car mass transit vehicles such as roadtrains comprise several connected cars on tyres, the vehicles capable of accommodating large numbers of people without the need for physical tracks.

Generally, industry uses a variant of what is known as a Jacobs bogie, which is well known on multicar railways. Jacobs bogies are a type of rail vehicle bogie commonly found on articulated railcars and tramway vehicles, and are placed between two carriages of the rail vehicle. The weight of each carriage is spread across the Jacobs bogie, and is arrangement provides the smooth ride of bogie carriages without the additional weight and drag.

Jacobs bogies cannot operate outside a rail scenario because they require train wheels and tracks to operate and steer.

Local mass transit vehicles which do not operate on rails, and instead use tyred wheels, are increasingly in use. Such vehicles are often in use in crowded streets and/or narrow streets and are looking to steering mechanisms which may enable the vehicle to circumnavigate obstacles easily. To this end, it is desirable to deploy a vehicle which is capable of all-wheel steering.

To achieve the desired manoeuvrability required for a city centre, semi-trailer steering would not be appropriate as the trailing cars will not follow the track of the lead car, and may cut into corners.

The lack of a bi-directional all-wheel steer arrangement remains an impediment in implementing a versatile multi-car roadtrain in an urban setting and it would indeed be difficult for a multi-car road-train based on semi-trailers to operate in such tight locations. Further, operators of such vehicles may be surprised when they are informed that these roadtrains cannot reverse.

Lightweight hand-towed trailers can have a detachable drawbar which can be fitted to either end of the trailer for pulling the trailer in the second direction. This differs from the present invention which applies to large road-going trains where the bi-directionality is integrated into the steering system such that a driver may switch directions without the need to remove drawbars.

Generally, industry uses a variant of what is known as four-wheel “Ackermann” (‘4WA’) steering to ensure each car in a roadtrain follows exactly a front (steering) car, minimising the track width required in crowded situations. Four-wheel “Ackermann” steering is not to be confused with conventional “Ackermann” steering methods which are generally operable on two-wheel steering arrangements.

4WA steering as known and in common with all multi-trailer systems cannot operate bi-directionally and will often quickly jack-knife when reversing—a limitation which would require additional route flexibility and laying of additional track or road to ensure the train or roadtrain may always travel in a forward direction.

In general, multi-car road vehicles, whether they use 4WA, semi-trailer or pivot steering, cannot adequately reverse—a system that relies on the drawbar to convey steering information to the car behind has been found not to work the other way around.

Such systems as discussed above are inaccurate following a path when following a power car which means they are unsuitable for constricted urban environments.

In general, multicar roadtrains connected by drawbars do not include gangways to connect one carriage to the next for the benefit of passengers.

An example of a multi-carriage roadtrain is the Zhuzhou autonomous tram. However, the individual carriages in the Zhuzhou autonomous tram each follow a fixed path using buried wires and/or visual guides on the road for direction. Therefore, this example does not provide the desired versatility, relying on prepared infrastructure for direction.

There is, therefore, a need to provide a multi-car mass transit vehicle intermediate carriage arrangement which alleviates one or more problems associated with the prior art.

A first aspect provides an intermediate carriage for a multi-carriage vehicle, the intermediate carriage configured to connect to first and second carriages, and the intermediate carriage including a steering input and a steering output, wherein the steering input is configured to accept a steering input from the first carriage, and the steering output is configured to provide a steering output to the second carriage.

Preferably, an input angle of the steering input determines an output angle of the steering output.

Conveniently, the intermediate carriage provides a relationship between the input angle and the output angle.

Advantageously, the steering input is provided by an input linkage connected to a steering control system and the first carriage.

Preferably, the input linkage is mounted on an extension to the first carriage.

Conveniently, the steering input and steering output connect to a steering arrangement.

Advantageously, the steering arrangement comprises a first gear connected to the steering input, and a second gear connected to the steering output.

Preferably, the gear ratio is 1:1.

Alternatively, the steering arrangement includes a linkage arrangement.

Conveniently, the linkage arrangement includes a first steering member, a second steering member, a slider channel, and a slider member.

Advantageously, the steering arrangement comprises one or more hydraulic or pneumatic actuators.

Alternatively, the steering arrangement comprises one or more electric motors.

Alternatively, the steering arrangement is powered.

Alternatively, the steering arrangement includes a damper or dampers.

In a further aspect, a method of steering an intermediate carriage includes a first car providing a steering input to an intermediate carriage, and the intermediate carriage providing a steering output to a second car.

A yet further aspect provides a multi-car mass transit vehicle comprising the intermediate carriage described herein.

Another aspect provides a kit of parts comprising an intermediate carriage as described herein and a plurality of carriages.

Embodiments of the steering system are described, by way of example, with reference to the accompanying drawings, in which:

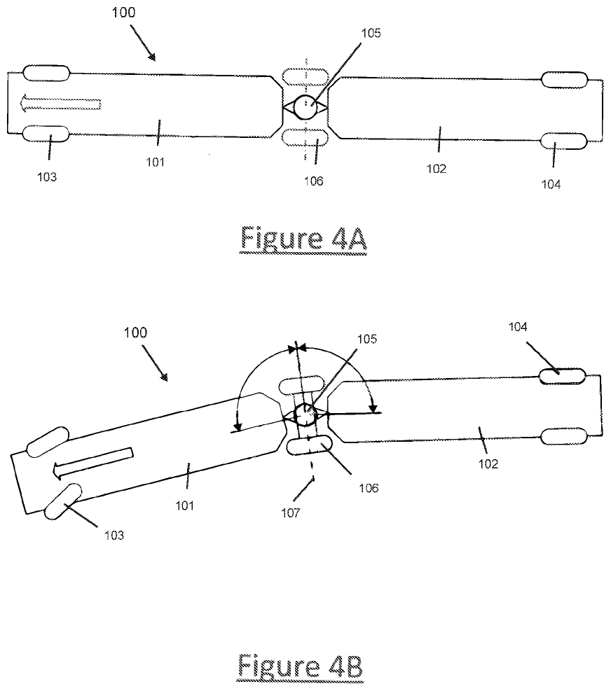

FIG. 4A shows a two-carriage vehicle with an intermediate carriage, the two-carriage vehicle in a first configuration;

FIG. 4B shows the two-carriage vehicle of FIG. 4A, the two-carriage vehicle in a second configuration;

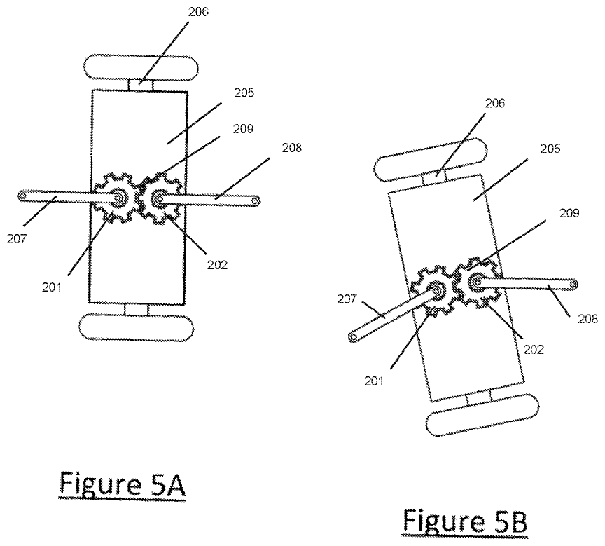

FIG. 5A shows an intermediate carriage having a first type of mechanism, the intermediate carriage in a first configuration;

FIG. 5B shows the intermediate carriage of FIG. 5A, the intermediate carriage in a second configuration;

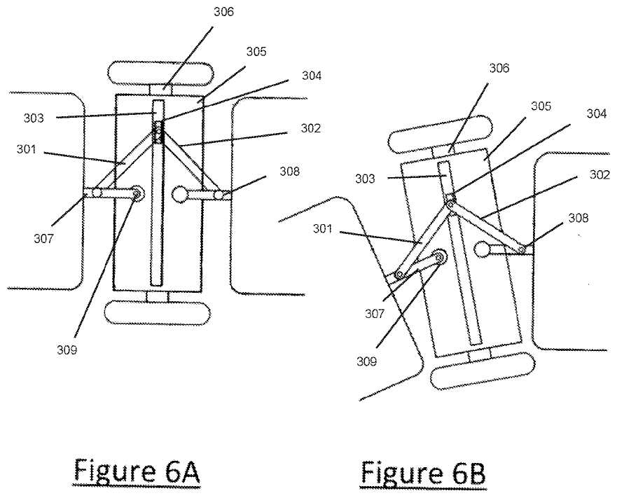

FIG. 6A shows an intermediate carriage having a second type of mechanism, the intermediate carriage in a first configuration; and

FIG. 6B shows the intermediate carriage of FIG. 6A, the intermediate carriage in a second configuration.

Referring firstly to FIG. 4A, there is shown a two-carriage vehicle 100, which is an example of a multi-car mass transit vehicle. The vehicle 10 includes a first carriage 101 and a second carriage 102, and an intermediate carriage 105.

The direction of travel of the two-carriage vehicle is indicated by the grey arrow in FIG. 4A.

The first carriage includes a first axle 103, and the second carriage includes a second axle 104. The first and second axles 103, 104 may be driven, or one of the first and second axles 103, 104 driven and the other undriven.

The intermediate carriage 105 includes an intermediate axle 106, and this intermediate axle 106 may be driven. Alternatively, the intermediate axle 106 may be undriven. In the case that the intermediate axle 106 is driven, the intermediate carriage may include a drive arrangement, and may further include a power source. Neither the power source nor the drive arrangement are shown in FIG. 4A.

In an example, the drive arrangement may be an electric motor, and the power source may be a battery or batteries, and the intermediate carriage 105 may further include a control arrangement to control the power source and drive arrangement.

Referring now to FIG. 4B, the two-carriage vehicle 100 of FIG. 4A is shown during a turning manoeuvre. The first axle 103 is steered such that the vehicle 100 turns left, and the first carriage 101 rotates with respect to the second carriage 102, about the chained line 107 shown in FIG. 4B.

In this type of turning manoeuvre, the intermediate carriage 105 provides a pivot point, about which the first and second carriages 101, 102 may rotate to allow the vehicle 100 to turn a corner.

In the arrangement shown in FIGS. 4A and 4B, the intermediate axle 106 is fixed, such that it may not steer with respect to the intermediate carriage 105, and the intermediate axle 106 and therefore the intermediate carriage 105 slews such that its position bisects the angle between the first carriage 101 and the second carriage 102. In the example shown, the first angle 108 and the second angle 109 are equal. In other examples, the intermediate carriage 105 may be configured such that the first and second angles 108, 109 are not equal.

As can be seen in FIGS. 4A and 4B, the intermediate carriage 105 does not trail the wheels of the first axle 103 as they would in a normal vehicle, but bisects the angle with the second carriage 102. This may cause the first carriage 101 to behave as a four-wheel steered unit, and may result in a smaller turning circle than a traditionally-steered vehicle, because the rear of the first carriage 101 will steer outwards, reducing the turning circle of the two-carriage vehicle 100.

The arrangement described above will also cause the second carriage 102 to follow the path of the first carriage 101, which contributes to the smaller turning circle and more accurate turning of the two-carriage vehicle 100.

As discussed above, the intermediate carriage 105 may be powered. In some examples, the intermediate carriage 105 may be the only source of power on the vehicle 100, propelling the vehicle 100 both forward and backward. The wheels of the first axle 103 of the first car 101 would steer in the usual way while the wheels of the second axle 104 of the second car 102 may be locked straight or may be caused to steer in sympathy with the wheels of the first axle 103.

The intermediate carriage 105 of FIGS. 4A and 4B has two wheels, but the intermediate carriage may have four wheels. The four wheels may be in a duplex configuration, or may be configured such that two wheels are on either side of the intermediate carriage 105.

The intermediate carriage 105 may be relatively shallow in height, to allow for a low floor in the first and second carriages 101, 102, and may allow the two-carriage vehicle 100 to be a walk-through vehicle, that is to say that the floor may on the same level all the way through the vehicle 100, such that a passenger may walk from one end of the vehicle 100 to the opposing end of the vehicle 100 without being inhibited by doors or changes of level.

Referring now to FIG. 5A, an intermediate carriage 205 is shown, which may be used as the intermediate carriage in the two-carriage vehicle 100 of FIGS. 4A and 4B. The intermediate carriage 205 may include an intermediate axle 206, with a wheel mounted on each of the free ends of the intermediate axle 206.

The intermediate carriage 205 may include a steering input 207 and a steering output 208, which may be connected together by way of a steering arrangement 209. The steering arrangement 209 of FIG. 5A may be a pair of gears, which may be complementary and may have the same number of teeth. This may ensure that the slew angle of the intermediate carriage 205 is the same with respect to the first and second carriages to which the intermediate carriage 205 may be coupled.

FIG. 5B shows the intermediate carriage 205 of FIG. 5A with an input applied to the steering input 207. The steering input 207 causes rotation of the first gear 201, which in turn rotates the second gear 202. The second gear 202 causes the steering output 208 to move with respect to the intermediate carriage 205, and the steering output 208 therefore provides an output.

Combining the intermediate carriage shown in FIGS. 5A and 5B with the example shown in FIGS. 4A and 4B, the first carriage 101 may be connected to the steering input 207 of the intermediate carriage 105, 205. When the first axle 103 is steered, as is shown in FIG. 4B, the steering input 207 of the intermediate carriage 105, 205 receives an input as is described above, and turns the first and second gears 201, 202 of the intermediate carriage 105, 205. This turning of the gears 201, 202 causes an output in the steering output 208, which in turn causes the second carriage 102 to follow the steering of the first carriage 101.

Returning to a discussion of FIGS. 4A and 4B, the intermediate axle 106 of the intermediate carriage 105 may be considered to be a central turntable axle which is linked to bisect the angles between the two adjacent carriages.

As discussed above, in essence this gives the driving car a 4 wheel steer mechanism which, for a long vehicle may be advantageous. The second carriage 102 will follow the steering path of the first carriage 101 but not so fast as to cut the corner.

The intermediate carriage 105 may be, in effect, be mounted on an extension to the first carriage 101 while the second carriage 102 is hitched as a trailer. It may also be the case that the geometry of the vehicle 100 is such that the turning of the first and second axles 103, 104 is symmetrical so the vehicle 100 may drive both ways equally easily.

Referring now to FIG. 6A, a different arrangement of an intermediate carriage 305 is shown. In a similar fashion to that shown in FIGS. 5A and 5B, the intermediate carriage 305 includes an intermediate axle 306, a steering input 307, and a steering output 308. The intermediate carriage 305 of FIG. 6A may include a steering arrangement 309 which includes a first steering member 301, a second steering member 302, a slider channel 303, and a slider member 304.

The first steering member 301 may be connected to the steering input 307 and the slider member 304, and the second steering member 302 may be connected to the steering output 308 and the slider member 304. In a similar way to the arrangement described in connection with FIGS. 5A and 5B above, the steering input, when rotated with respect to the intermediate carriage 305, may cause the first steering member 301 to move. Given that a first end of the first steering member 301 is pivotably affixed to the steering input 307 and a second end of the first steering member 301 is pivotably affixed to the slider member 304, the rotation of the steering input 307 may cause the slider member 304 to slide within the slider channel 303.

This movement may in turn cause the second steering member 302 to move, and as with the first steering member 301 a first end of the second steering member 302 is pivotably affixed to the steering output 308 and a second end of the second steering member 302 is pivotably affixed to the slider member 304, the movement of steering input 307 and thus the first steering member 301 may cause complementary movement of the second steering member 302 and thus the steering output 308.

FIG. 6B shows the intermediate carriage 305 of FIG. 6A with an input applied to the steering input 307. The steering input 307 causes movement of the slider member 304 within the slider channel 303, which in turn causes movement of the steering output 308, by way of the first and second steering members 301, 302.

Combining the intermediate carriage shown in FIGS. 6A and 6B with the example shown in FIGS. 4A and 4B, the first carriage 101 may be connected to the steering input 307 of the intermediate carriage 105, 305. When the first axle 103 is steered, as is shown in FIG. 4B, the steering input 307 of the intermediate carriage 105, 305 receives an input as is described above, and moves the steering input 301 as described above, which in turn causes movement of the slider member 304 within the slider channel 303. This movement of the first steering member 301 therefore causes a movement of the second steering member 302 which causes an output in the steering output 308, which in turn causes the second carriage 102 to follow the steering of the first carriage 101.

In the examples described above, the first and second steering members 301, 302 are of equal length, which may cause the slew angle of the intermediate carriage 305 to bisect the angle between the first and second carriages 101, 102. In some examples, the actual or effective lengths of the first and second steering members 301, 302 may be changed, which may effect a difference in the slew angle of the intermediate carriage 305. The effective or actual lengths of the first and second steering members 301, 302 may be changeable in real-time, for example by the driver of such a vehicle, or such a change may be made automatically in response to factors such as the speed of the vehicle or the angle at which the first carriage 101 may be steered.

The slew angle of the intermediate carriage may also be modified in dependence upon the direction of the vehicle 100.

In some examples, the steering of the intermediate carriage 105, 205, 305 may be damped such that the steering input 207, 307 and the steering output 208, 308 are connected to dampers which may increase the smoothness of the movement of the vehicle 100.

It in some examples, the steering input 207, 307 and the steering output 208, 308 along with the first and second gears 201, 202, and/or the steering members 301, 302, slider member 304 and the slider channel 303 may be considered to be a steering control system or a steering arrangement. The steering members 301, 302, the slider member 304, and the slider channel 303 may be considered as a linkage arrangement.

A multi-carriage vehicle 100 in accordance with the foregoing description may confer a number of advantages. Such advantages may include the multi-carriage vehicle 100 having a low floor, and the carriages of the vehicle 100 being joined up, that is to say that the vehicle 100 may be open from one end to the other. This may allow more passengers to be accommodated in the vehicle 100 and may allow the vehicle 100 to be more accessible to passengers who may have difficulties with mobility.

In addition, such an intermediate carriage may enable the carriages of the multi-carriage vehicle 100 to be coupled more simply, and more closely. The intermediate carriage may also allow the multi-carriage vehicle 100 to have a smaller turning circle, may provide more accurate and stable steering. Particularly, the steering may be more stable than a conventional four-wheel steering arrangement.

In use, the multi-carriage vehicle 100 may be travelling in a first direction. With reference to FIG. 4B, the multi-carriage vehicle 100 may commence a turning manoeuvre. The first carriage 101 steers left, and provides a steering input into the intermediate carriage 105. The intermediate carriage 105 slews to bisect the angle between the first and second carriages 101, 102, and causes the first carriage 101 to four-wheel steer. The second carriage 102 follows the turning angle of the first carriage 101 by way of the steering output from the intermediate carriage 105.

In such a scenario, the multi-carriage vehicle 100 may be configured to drive in that particular direction, and may include systems to configure the first and second carriages 101, 102 and the intermediate carriage 105 to travel in this direction. Such systems may be mechanical or electrical, and may include a switch to configure the direction of travel.

When the vehicle 100 reaches a destination, it may need to reverse. The driver or operator may simply switch the desired direction as described above. The vehicle 100 may now be operable in the ‘reverse’ direction in the same way it was in the ‘forward’ direction. As such, the previous end car is now the front car and may operate in the same way as disclosed above, and there is no need to attempt to turn the whole multi-carriage vehicle 100 in order to travel in the reverse direction.

In embodiments, the steering system may be retrofitted to existing multi-car vehicles. Accordingly, a kit of parts is provided comprising an intermediate carriage for a multi-carriage vehicle, the intermediate carriage configured to connect to first and second carriages, and the intermediate carriage including a steering input and a steering output, such that the steering input is configured to accept a steering input from the first carriage, and the steering output is configured to provide a steering output to the second carriage.

A method of steering a multi-car mass transit vehicle is also provided. The method comprises providing an intermediate carriage for a multi-carriage vehicle, the intermediate carriage configured to connect to first and second carriages, and the intermediate carriage including a steering input and a steering output, such that the steering input is configured to accept a steering input from the first carriage, and the steering output is configured to provide a steering output to the second carriage, and connecting the intermediate carriage to first and second carriages.

One example of a multi-car mass transit vehicle may be a roadtrain. This may be advantageous so that multi-car vehicle may travel in two directions without the need for additional infrastructure and be more manoeuvrable and versatile in tighter spaces.

In some embodiments, the precision of the steering of a roadtrain with or without bidirectionality may be further enhanced by a guidance system such as Wireguide®. If the Wireguide® system and the bi-directional steering system are combined, the operator or driver will be able to take advantage of automatic and reliable precision steering of long vehicles, with a combined steering error of around 100 mm—when needed—with the ability to depart from the prepared route when necessary.

It will be appreciated that the disclosed embodiments are not restricted by size or type of vehicle and can be applied to many different multi-car steering systems, for example, with power-assist steering systems. While the steering system may be particularly suitable for road vehicles, rail vehicles may also benefit from the steering system.

It will be appreciated that the steering system may be advantageous for turning of a multi-car mass transit vehicle. Conversely, it may be advantageous to de-tune or disengage the steering system at high speeds due to possible weaving of the cars.

This specification relates to tyre-wheeled carriage systems for multi-car mass transit vehicles. Further, it is a non-exclusive object of this specification to provide a mass-transit vehicle carriage system that is more versatile, deployable, provides low floors in the carriages and also has the potential to increase stability of such a vehicle.

Multi-car mass transit vehicles such as roadtrains comprise several connected cars on tyres, the vehicles capable of accommodating large numbers of people without the need for physical tracks.

Local mass transit vehicles which do not operate on rails, and instead use tyred wheels, are increasingly in use. Such vehicles do not always cater for those who are mobility impaired.

A vehicle which has a lower floor provides better accessibility for those with limited mobility, and may also provide more internal space to enable the vehicle to carry more passengers.

In addition, a lower-floored vehicle may have a lower centre of gravity which may in turn increase the stability of such a vehicle. A bogie arrangement, traditionally used in rail vehicles, may allow a roadtrain to have a lower floor and better accessibility, by means of groups of smaller tyred wheels rather than one or two axles of bigger wheels such as used on buses and road-going trams, whereby groups of wheels can alleviate the relatively low weight capacity of the smaller diameter.

There is, therefore, a need to provide a multi-car mass transit vehicle bogie arrangement which alleviates one or more problems associated with the prior art.

A first aspect provides a tyre-wheeled bogie arrangement for a vehicle, the bogie arrangement including a bogie body and at least one wheel including a tyre.

Preferably, the bogie arrangement includes at least two wheels including a tyre on each side of the bogie arrangement.

Conveniently, the at least two wheels on each side of the bogie arrangement are duplex wheels.

A further aspect provides a multi-car mass transit vehicle comprising the tyre-wheeled bogie arrangement as described herein.

A yet further aspect provides a kit comprising the tyre-wheeled bogie arrangement as described herein and a vehicle body.

Embodiments of the bogie arrangement are described herein, by way of example.

An existing bogie arrangement for a rail vehicle may include rail wheels, that is to say wheels which are configured to operate on rail tracks. Such a bogie may be modified to replace the rail wheels on the bogie with tyred wheels. This arrangement is termed a tyre-wheeled bogie arrangement.

This tyre-wheeled bogie arrangement may be mounted to a roadtrain or other road-going passenger vehicle, and may include steering axles, or the tyre-wheeled bogie may be slewed to allow the vehicle to steer.

A tyre-wheeled bogie may confer advantages over a traditional road-going axle and wheel arrangement. For example, four wheels allows for greater loading than two wheels for the same size wheel. A particular advantage to this arrangement is wheels smaller than on a traditional road-going vehicle axle may be used, which may give rise to the advantage that the floor height of the vehicle close to the ground.

This may improve the accessibility of the vehicle for those passengers who are mobility-impaired.

Additionally, a larger number of smaller wheels may increase the load that the roadtrain or similar vehicle may be able to carry. The greater number of wheels, the more the load is split between the wheels. This may advantageously allow the vehicle to carry more weight and therefore more passengers, and may give the vehicle more resilience in that it could be more tolerant of punctures or other damages to the wheels and/or tyres.

Further load-sharing may be achieved by placing duplex wheels and tyres on axles of the tyre-wheeled bogie arrangement; putting two wheels on either side of each axle may allow for a greater number of tyred wheels, and therefore a lesser load per wheel and tyre.

A further advantage may be that of the smaller wheels on a tyre-wheeled bogie arrangement may be more easily hidden because they do not need as much space as traditional wheels when turning. This may give rise to a vehicle with a wider track and greater stability. It may also improve the overall aesthetic of the vehicle.

It will be appreciated that the disclosed embodiments are not restricted by size or type of vehicle and can be applied to many different multi-car steering systems, for example, with power-assist steering systems. While the steering system may be particularly suitable for road vehicles, rail vehicles may also benefit from the steering system.

It will be appreciated that the steering system may be advantageous for turning of a multi-car mass transit vehicle. Conversely, it may be advantageous to de-tune or disengage the steering system at high speeds due to possible unstable weaving of the cars.

While the invention has been illustrated and described in detail in the drawings and preceding description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. Each feature of the disclosed embodiments may be replaced by alternative features serving the same, equivalent or similar purpose, unless stated otherwise. Therefore, unless stated otherwise, each feature disclosed is one example of a generic series of equivalent or similar features.

In the claims, the word “comprising” does not exclude other elements or steps, and the indefinite article “a” or “an” does not exclude a plurality. Any reference signs in the claims should not be construed as limiting the scope.

1. A steering system for a multi-car mass transit vehicle, the steering system comprising a drawbar attachable to steering systems of first and second cars of the multi-car mass transit vehicle, wherein the steering system is configured such that the drawbar provides the steering input for the first car when configured to move in a first direction, and provides the steering input for the second car when configured to move in a second direction.

2. The steering system of claim 1, further comprising a first wheel axle and a second wheel axle, the drawbar being connected to the first wheel axle and the second wheel axle such that the drawbar steering input provides the steering input for the first and second wheel axles.

3. The steering system of claim 1 or 2, wherein the drawbar steering input steers the first wheel axle in an opposite direction to the second wheel axle.

4. The steering system of claim 3, wherein the drawbar steering input provides a steering input to the first wheel axle and is connected to the second wheel axle to effect the steering of the second wheel axle with respect to the first wheel axle.

5. The steering system of any preceding claim, wherein the steering systems of the first and second cars are four-wheel steering systems.

6. The steering system of any preceding claim, wherein the steering systems of the first and second cars steer two wheels in a first direction and two wheels in an opposite direction.

7. The steering system of any preceding claim, wherein the steering systems of the first and second cars comprise a bellcrank or turntable and rigid linkage arrangement, the drawbar being attached to the bellcrank or turntable, the bellcrank or turntable being attached to rigid linkages, the rigid linkages being attached to wheel mounts of the car such that movement of the drawbar moves the first and second wheel axles and wheel mounts.

8. The steering system of claim 7, wherein the steering systems of the first and second cars further comprise a crank located adjacent a first wheel axle, the crank being connected, via rigid linkages, to the bellcrank or turntable and the wheel mounts of the first wheel axle.

9. The steering system of claim 8, further comprising a second crank located adjacent a second wheel axle and connected to a second bellcrank or turntable and wheel mounts of the second axle wherein the second crank is connected to the first crank.

10. The steering system of claim 9, wherein a drawbar of another car is attached to the second bellcrank or turntable.

11. The steering system of claim 10, wherein the first crank is connected to the second crank at opposing attachment portions such that rotation of one crank causes opposite rotation of the other crank.

12. The steering system of any of claims 8 to 11, wherein the crank is formed of a T-piece configured to relay linear movement of the rigid linkages.

13. The steering system of any of claims 7 to 12, further comprising one or more centring linkages operable to either restrict or permit limited movement of the drawbar relative to the bellcrank or turntable.

14. The steering system of claim 13, wherein the centring linkages are pneumatic centring linkages.

15. The steering system of claim 13 or 14, further comprising a switch for a driver or operator of the vehicle which controls when the pneumatic centring linkages either restrict or permit limited movement of the drawbar relative to the bellcrank or turntable.

16. The steering system of claim 13, 14 or 15, wherein centring linkages are provided for each bellcrank or turntable such that movement at each end of the drawbar may be permitted or restricted relative to the respective bellcrank or turntable.

17. The steering system of any of claims 1 to 6, wherein the steering systems of the first and second cars comprise a hydraulic system, the hydraulic system comprising first and second pistons, the first and second pistons each being attached to opposite sides of the drawbar and in fluid connection with first and second wheel mount pistons.

18. The steering system of claim 17, wherein the hydraulic system further comprises third and fourth pistons each being attached to opposite sides of a second drawbar and in fluid connection with first and second wheel mount pistons.

19. The steering system of claim 17 or 18, wherein the hydraulic system is a closed loop system, with all of the pistons being in fluid connection.

20. The steering system of claim 17, 18 or 19, wherein the hydraulic system comprises a switch for a driver or operator of the vehicle which controls when the pistons either restrict or permit limited movement of the drawbar.

21. A method of steering a multi-car mass transit vehicle, the method comprising:
connecting a plurality of cars via drawbars, a steering system of each car being configured for the drawbars to provide an input to the steering systems;
setting a switch to activate each steering system for a desired direction of travel; and
driving the multi-car mass transit vehicle.

22. The method of claim 21, further comprising:
reaching a destination;
switching the steering systems to a different desired direction; and
driving the multi-car mass transit vehicle.

23. The method of claim 22, wherein setting a switch to activate each steering system or switching the steering system to a different desired direction comprises:
when configured to travel in a first direction, the steering system restricts movement of all the drawbars of the multi-car mass transit vehicle at each same first end and permits limited movement of all the drawbars at each same second end, and
when configured to travel in a second direction, the steering system restricts movement of the all the drawbars of the multi-car mass transit vehicle at a same second end and permits limited movement of all the drawbars at the same first end.

24. The method of claim 21, 22 or 23, wherein the multi-car mass transit vehicle is driven by a power car or each car comprises bi-directional electric motors and a power supply.

25. A multi-car mass transit vehicle comprising the steering system of claims 1 to 16 and/or claims 1 to 6 and 17 to 20.

26. A kit comprising the steering system of claims 1 to 16 and/or claims 1 to 6 and 17 to 20 and a plurality of cars.

27. An intermediate carriage for a multi-carriage vehicle, the intermediate carriage configured to connect to first and second carriages, and the intermediate carriage including a steering input and a steering output, wherein:
the steering input is configured to accept a steering input from the first carriage; and
the steering output is configured to provide a steering output to the second carriage.

28. The intermediate carriage of claim 27, wherein an input angle of the steering input determines an output angle of the steering output.

29. The intermediate carriage of claim 28, wherein the intermediate carriage provides a relationship between the input angle and the output angle.

30. The intermediate carriage of any one of claims 27 to 29, wherein the steering input is provided by an input linkage connected to a steering control system and the first carriage.

31. The intermediate carriage of claim 30, wherein the input linkage is mounted on an extension to the first carriage.

32. The intermediate carriage of any of claims 27 to 31 wherein the steering input and steering output connect to a steering arrangement.

33. The intermediate carriage of claim 31, wherein the steering arrangement comprises a first gear connected to the steering input, and a second gear connected to the steering output.

34. The intermediate carriage of claim 33, wherein the gear ratio is 1:1.

35. The intermediate carriage of claim 32, wherein the steering arrangement includes a linkage arrangement.

36. The intermediate carriage of claim 35, wherein the linkage arrangement includes a first steering member, a second steering member, a slider channel, and a slider member.

37. The intermediate carriage of any one of claims 32 to 36, wherein the steering arrangement comprises one or more hydraulic or pneumatic actuators.

38. The intermediate carriage of any one of claims 32 to 36, wherein the steering arrangement comprises one or more electric motors.

39. The intermediate carriage of any one of claims 32 to 38 wherein the steering control system is powered.

40. The intermediate carriage of any one of claims 32 to 39, wherein the steering arrangement includes a damper or dampers.

41. A method of steering a multi-car vehicle, a first car providing a steering input to an intermediate carriage, the intermediate carriage providing a steering output to a second car.

42. A multi-car mass transit vehicle comprising the intermediate carriage of claims 27 to 40.

43. A kit comprising the intermediate carriage of claims 27 to 40 and a plurality of carriages.

44. A tyre-wheeled bogie arrangement for a vehicle, the bogie arrangement including a bogie body and at least one wheel including a tyre.

45. The tyre-wheeled bogie arrangement of claim 44, wherein the bogie arrangement includes at least two wheels including a tyre on each side of the bogie arrangement.

46. The tyre-wheeled bogie arrangement of claim 45, wherein the at least two wheels on each side of the bogie arrangement are duplex wheels.

47. The tyre-wheeled bogie arrangement of any of claims 44 to 46, wherein the bogie arrangement steers the vehicle by slewing the bogie.

48. A multi-car mass transit vehicle comprising the tyre-wheeled bogie arrangement of claims 44 to 47.

49. A kit comprising the tyre-wheeled bogie arrangement of claims 44 to 46 and a vehicle body.
